(19) United States
(12) Patent Application Publication
(10) Pub. No.: US 2008/0161498 A1
(43) Pub. Date: Jul. 3, 2008

(54) Polypropylene derivatives and preparation thereof

(75) Inventors: Lien Tai Chen, Taoyuan City (TW); Chi-Wei Hsu, Hsinchu County (TW); Tun-Fun Way, Hsinchu (TW); Jian-Lin Hua, Taichung City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/907,593

(22) Filed: Oct. 15, 2007

(30) Foreign Application Priority Data
Dec. 28, 2006 (TW) 95149469

(51) Int. Cl. C08F 255/08; C08F 4/04; C08F 4/30

(52) U.S. Cl. 525/260; 525/264

(57) ABSTRACT

A polypropylene derivative is provided. The polypropylene derivative includes a reactive monomer grafted on polypropylene, with a grafting yield exceeding 5%. A method of preparing the polypropylene derivative is also disclosed. The method includes mixing a reactive monomer, polypropylene, and a compatibilizer in a twin screw extruder to prepare a polypropylene derivative with reactive monomers grafted thereon, with a grafting ratio exceeding 5%.

### BACKGROUND OF THE INVENTION

1. Field of the Invention

The invention relates to derivatives of polyolefin polymers, and in particular to polypropylene derivatives and preparation method thereof.

2. Description of the Related Art

Polypropylene (PP) is widely used in apparel textiles, automobile textiles, leisure products, suitcases, carpets, and ropes etc. Though with such a wide range of applications, use of polypropylene is still limited by its chemical inertness and difficulty to blend with other polymers for specialty applications. Moreover, one important feature of polypropylene that requires improvement is its coloring. Currently, polypropylene is colored by blending pigments into the polymer, or into the spinning dope in the case of fiber production. Although deep-color polypropylene materials can thus be obtained, the variety of colors achievable is rather limited in comparison with conventional dying of polyesters and polyamides. The limitation originates from difficulty in precision tuning of colors by the pigment blending process. Furthermore, complete cleaning of the blending machine to avoid batch-to-batch contamination is costly and difficult.

Polyalkenes and their copolymers with maleic anhydride (MAH) or other reactive comonomers grafted thereon have been disclosed. R. A. Zelonka and C. S. Wong (U.S. Pat. No. 4,612,155) disclosed formation of the polyalkene materials with unsaturated reactive monomers grafted thereon by a twin-screw extruder. Steinkamp (U.S. Pat. No. 3,862,265 and U.S. Pat. No. 4,001,172) disclosed modified polyolefins with the MFR up to 1000 dg/min via extrusion reaction; however, they could only achieve an MFR of 71 dg/min for polypropylene. The percent of MAH grafted to PP is as low as 0.53% by weight.

V. Flaris (U.S. Pat. No. 6,228,948) disclosed an MAH grafted polypropylene with a grafting ratio of 1.5˜3.8% by weight. The grafting reaction was conducted in a high-speed twin-screw extruder. J. L. Pradel (U.S. Pat. No. 7,067,196) disclosed blending of a grafted polypropylene binder with other materials for application in films and packaging materials in 2006. M. G. Botros (U.S. Pat. No. 7,030,188) disclosed a MAH grafted polypropylene-polyethylene copolymer with a grafting ratio of 2.17% with addition of Luperox101 as an initiator. The resultant materials are intended for use in thermal plastics and filtration.

In all the searched literature, the grafting ratio of polypropylene derivatives is all less than 5%, indicating that a technical barrier for achieving high grafting ratio exists. Though polypropylene has been widely used in many applications, modification of polypropylene with additional or enhanced functionalities shall allow it to penetrate even more markets. This invention discloses novel polypropylene derivatives, and the manufacture method thereof, with a functional comonomer grafting ratio exceeding 5%.

### SUMMARY OF THE INVENTION

One embodiment of, the invention provides polypropylene derivatives comprising a reactive monomer grafted on a main chain of a polypropylene molecule, with a grafting ratio exceeding 5%.

Another embodiment of the invention provides a method of preparing polypropylene derivatives comprising mixing a reactive monomer, polypropylene molecules, and a compatibilizer in a twin screw extruder to induce grafting reaction, in which the reactive monomer becomes the side chain of the polypropylene molecules.

A detailed description is given in the following embodiments.

### DETAILED DESCRIPTION OF THE INVENTION

The following description is of the best-contemplated mode of carrying out the invention. The following description is made for the purpose of illustrating the general principles of the invention and should not be taken in a limiting sense. The scope of the invention is best determined by reference to the appended claims.

One embodiment of the invention provides polypropylene derivatives comprising a reactive monomer grafted onto polypropylene. The polypropylene derivatives have grafting ratios exceeding 5%, preferably 6%.

The reactive monomer grafted onto polypropylene may comprise methyl methacrylate (M-MA), ethyl methacrylate (EMA), or styrene.

One embodiment of the invention provides a method of preparing polypropylene derivatives comprising mixing a reactive monomer, polypropylene molecules, and a compatibilizer in a twin screw extruder to induce grafting reaction in which the reactive monomer is grated as the side chain; of the polypropylene molecule. The polypropylene derivatives generally have grafting ratios exceeding 5%.

The compatibilizer may comprise block copolymers of polypropylene and various polyacrylates, such as polypropylene-co-poly(methyl methacrylate), polypropylene-co-poly(ethyl methacrylate), polypropylene-co-poly(methyl ethacrylate), and polypropylene-co-poly(ethyl ethacrylate), etc. The reactive monomer has a weight ratio of about 5˜25% or 10˜15%. The compatibilizer has a weight ratio of about 10˜50% or 30˜40%.

An additional initiator is added into the twin screw extruder to trigger the reaction. The initiator may comprise peroxides such as benzoyl peroxide (BPO) or azo compounds such as 2,2′-Azobisisobutyronitrile (AIBN).

### COMPARATIVE EXAMPLE 1

0.5 g polypropylene powder and 0.2 g 2-hydroxy-2-methylproptophemone, used as an initiator, were added to 10 ml methanol. The mixture was stirred to form uniform slurry. Then 2 ml methyl methacrylate (MMA) monomer was added into the slurry. Grafting reaction between MMA and polypropylene, was performed in the solid state after heating with a 100 W ultraviolet lamp. The reaction was allowed to proceed for 4 hours. After the reaction was completed, the reaction mixture was filtered. The retained solid was washed with 50 ml acetone and dried repeatedly for three times. White powder of polypropylene-g-polymethyl methacrylate (PP-g-PMMA) was then obtained. The NMR and IR tests indicate the grafting ratio about 4%, as shown in Table 1.

### COMPARATIVE EXAMPLE 2

0.5 g benzoyl peroxide (BPO) and 6 g methyl methacrylate (MMA) were mixed and stirred in a beaker at room temperature until the benzoyl peroxide was completely dissolved. The solution was then. slowly dropped into 53.5 g polypropylene powder, and the blend was well stirred. The polypropylene powder was then subjected to twin screw extrusion to induce melt reaction. Grafting reaction between MMA and polypropylene occurs and PP-g-PMMA was formed. However, the resultant polymer may contain PP-g-PMMA and other polymers such as polypropylene or PMMA homopolymer as a result of the complex melt reactions.

The resultant polymer was purified by the following steps to obtain pure PP-g-PMMA. 1 g polymer and 50 ml xylene were mixed in a 500 ml flask and the flask was heated to 90˜100° C. in an oil bath until the reaction mixture was completely dissolved and a clear solution was formed. The polymer solution was then cooled to room temperature, and 50 ml acetone was added to induce precipitation of white solid. The white solid was obtained by air-suction assisted filtration. The white solid was washed with 50 ml acetone three times. After drying in a vacuum oven at 80° C., pure PP-g-PMMA with a grafting ratio of about 3.8% was prepared.

### COMPARATIVE EXAMPLE 3

0.5 g benzoyl peroxide (BPO) and 6 g methyl methacrylate (MMA) were mixed and stirred in a beaker at room temperature until the benzoyl peroxide was completely dissolved. The resulting solution was slowly dropped into 53.5 g “polypropylene chips” and the blend was well stirred. The polypropylene chips were then subjected to twin screw extrusion at ca. 210 oC to induce melt reaction to obtain a mixture polymer containing polypropylene-g-polymethyl methacrylate (PP-g-PMMA) as in Comparative Example 2.

The mixture was then purified by the following steps. 1 g mixture polymer and, 50 ml xylene were mixed and stirred in a 500 ml round bottom flask and heated to 90˜100° C. until the mixture is completely dissolved to form a clear solution. The solution was then cooled to room temperature, and 50 ml acetone was added into the solution to induce precipitation of white solid. The white solid was separated by air-suction assisted filtration, and followed by washing with 0.50 ml acetone three times. After drying in a vacuum oven at 80° C., pure white solid of PP-g-PMMA with a grafting ratio of about 0.2% was obtained.

### EXAMPLE 1

0.3 g benzoyl peroxide (BPO) and 6 g methyl methacrylate (MMA) were mixed and stirred in a beaker at room temperature until the benzoyl peroxide was completely dissolved. The resulting solution was then slowly dropped into a mixture of 25 g polypropylene and 5 g PP-g-PMMA chips, and, the mixture was stirred. The wet-chip blend was subsequently charged into a twin screw reactor to induce melt reaction to obtain a mixture polymer containing polypropylene-g-polymethyl methacrylate (PP-g-PMMA).

The polymer mixture was then purified by the following steps. 1 g mixture and 50 ml xylene were mixed and heated in a 500 ml flask to 90˜100° C. until the mixture was completely dissolved to form a clear solution. The solution was then cooled to room temperature, and 50 ml acetone was added into the solution to induce precipitation of white solid. The white solid was then separated by air-suction assisted filtration, and followed by washing with 50 ml acetone three times. After drying in a vacuum oven at 80° C., pure white solid of PP-g-PMMA with a grafting ratio of about 0.2% was obtained. The composition of PP-g-PMMA solid was confirmed by FTIR analysis. The grafting ratio of the sample thereof was calculated by comparison of the peak areas of the aldehyde group (C═O) (1736 cm⁻¹) and the methyl group (CH₃) (2722 cm⁻¹) in the FTIR spectra. As a result, a polypropylene-g-polymethyl methacrylate (PP-g-PMMA) polymer with a grafting yield of about 6.26% was prepared.

TABLE 1

| No. | PP | Monomer | Compatibilizer | Grafting rate (%)^{a} |
|---|---|---|---|---|
| Comparative | powder | MMA | N | 4.45 |
| Example 1 | | | | |
| Comparative | powder | MMA | N | 3.80 |
| Example 2 | | | | |
| Comparative | chip | MMA | N | 0.25 |
| Example 3 | | | | |
| Example 1 | powder | MMA | Y | 6.26 |

^{a}The grafting rate is determined by IR.

While the invention has been described by way of examples and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A polypropylene derivative comprising a grafted monomer with a grafting ratio exceeding 5%.

2. The polypropylene derivative as claimed in claim 1, wherein the grafted monomer comprises methyl methacrylate (MMA), ethyl methacrylate, (EMA), or styrene.

3. The polypropylene derivative as claimed in claim 1, wherein the polypropylene derivative has a grafting ratio exceeding 6%.

4. A method of preparing a polypropylene derivative comprising mixing a reactive monomer, polypropylene, and a compatibilizer in a twin screw extruder to prepare a polypropylene derivative with reactive monomers grafted thereon, with a grafting ratio exceeding 5%.

5. The method of preparing a polypropylene derivative as claimed in claim 4, wherein the compatibilizer comprises surfactants.

6. The method of preparing a polypropylene derivative as claimed in claim 5, wherein, the surfactant comprises polypropylene-containing surfactants.

7. The method of preparing a polypropylene derivative as claimed in claim 4, wherein the reactive monomer has a weight ratio of about 5˜25%.

8. The method of preparing a polypropylene derivative as claimed in claim 4, wherein the reactive monomer has a weight ratio of about 10˜15%.

9. The method of preparing a polypropylene derivative as claimed in claim 4, wherein the compatibilizer has a weight ratio of about 20˜50%.

10. The method of preparing a polypropylene derivative as claimed in claim 4, wherein the compatibilizer has a weight ratio of about 30˜40%.

11. The method of preparing a polypropylene derivative as claimed in claim 4, further comprising adding an additional initiator in the twin screw extruder to promote the grafting reaction.

12. The method of preparing a polypropylene derivative as claimed in claim 11, wherein the initiator comprises peroxide or azo compound.

13. The method of preparing a polypropylene derivative as claimed in claim 12, wherein the peroxide comprises benzoyl peroxide (BPO).

14. The method of preparing a polypropylene derivative as claimed in claim 12, wherein the azo compound comprises 2,2′-Azobisisobutyronitrile (AIBN).
